(19) United States
(12) Patent Application Publication
(10) Pub. No.: US 2015/0004937 A1
(43) Pub. Date: Jan. 1, 2015

(54) FINGERPRINTING A MOBILE DEVICE THROUGH NEAR FIELD COMMUNICATION

(71) Applicant: NexKey, Inc., Menlo Park, CA (US)

(72) Inventors: Gary Kremen, Fremont, CA (US); Jason Hart, Fremont, CA (US); Matthew Herscovitch, Fremont, CA (US)

(21) Appl. No.: 14/318,444

(22) Filed: Jun. 27, 2014

Related U.S. Application Data
(60) Provisional application No. 61/841,238, filed on Jun. 28, 2013.

(51) Int. Cl. H04W 12/08; H04B 5/00

(52) U.S. Cl. CPC H04W 12/08; H04B 5/0031
USPC 455/411

(57) ABSTRACT

Some embodiments include a method of operating an identity receiver of a security system to process an authentication request. The method can include detecting an energy signal from a mobile device at the identity receiver using a first communication protocol; generating a handover message at the identity receiver to request a unique characteristic of the mobile device using the first communication protocol, the unique characteristic associated with a second communication protocol; receiving the unique characteristic from the mobile device at the identity receiver; and authorizing access through the security system by matching the unique characteristic to an authorized identity stored in the identity receiver.

### CROSS-REFERENCE TO RELATED APPLICATION(S)

This application claims the benefit of U.S. Provisional Patent Application Ser. No. 61/841,238, entitled “SYSTEMS AND METHODS FOR FINGERPRINTING A MOBILE DEVICE THROUGH NEAR FIELD COMMUNICATION,” which was filed on Jun. 28, 2013, which is incorporated by reference herein in its entirety.

### RELATED FIELDS

This disclosure relates generally to a security system, and in particular to providing a security system that authenticates access through a mobile device.

### BACKGROUND

A typical electronic security system prevents or allows access to a goal in response to performing an authentication process. For example, the goal can be a restricted physical space, restricted information, or the execution of a desired task or the processing of a software program call. A physical electronic security system may include a barrier, barrier fixation hardware to secure the barrier, and a security intelligence device that engages or disengages the barrier fixation hardware. The security intelligence device generally determines accessibility through the barrier based on the identity of a user. The security intelligence device can receive identity information from an electronic key possessed by the user to determine the identity of the user. The identity information has to be able to positively identify the electronic key or at least the user.

The electronic key, for example, can take the form of a mobile smart phone. A mobile smart phone is a general-purpose device with an operating system to run multiple third-party software modules, optionally including a key module to configure the mobile smart phone as an electronic key (e.g., by presenting a digital identification). In the modern day society, many people carry a mobile smart phone, making it convenient to double as an electronic key. However, the mobile smart phone may or may not have an application that presents the digital identification, and/or a handheld vendor (e.g., Apple™, Samsung™) may limit access to one or more unique identifiers of the mobile smart phone thus making it difficult to present the digital identification.

### DISCLOSURE OVERVIEW

Disclosed is a security system utilizing a handover message between two communication protocols to retrieve a unique identifier of an external device (e.g., a mobile phone, tablet, or other device). The handover message is configured in accordance with a handover protocol that was created to help devices switch between communication channels to improve communication speed, performance, or range and to avoid an additional complicated handshake mechanism that needs to occur when opening a second communication channel. The disclosed security system utilizes the handover protocol to enable retrieval of the unique identifier to authenticate the external device. Hence, the second communication channel is abandoned when the unique identifier is received.

For example, the security system can utilize near field communication (NFC) to uniquely identify a mobile device. This enables the mobile device to serve as an electronic key when no corresponding application (i.e., an application that generates and/or presents a unique identifier) is running on an operating system of the mobile device or when access to a preferred unique identifier of the mobile device is restricted by the hardware or operating system of the mobile device. The security system may provide access through a barrier (e.g., physical or virtual) by verifying the identity of a user via the mobile device. In accordance with various embodiments, an identity receiver can cause the mobile device to transfer its digital identity to the identity receiver via the handover protocol. The digital identity can be stored in the identity receiver during a key acquisition process and matched against known authorized identities during a key authentication process. For example, the identity receiver can be in the form of an electronic locking cylinder, an electronic lock, or a device coupled to an electronic lock.

The handover process involves at least two communication protocols. In some embodiments, the first communication protocol used to initiate the authentication process is the NFC protocol. The NFC protocol is advantageous because of the proximity requirement (i.e., because proximity is required to communicate, there is less opportunity for security breaches from a third party intercepting communications between the mobile device and the identity receiver) and the built-in cryptographic features. In some embodiments, the identity receiver may even derive its power fully or partially from the NFC field generated by the mobile device.

In some embodiments, the authentication process begins when a user of the mobile device holds the mobile device near the identity receiver to gain access or entry through a barrier (e.g., a physical or a virtual barrier) that is otherwise protected by the security system. In the example of a physical barrier, the identity receiver is coupled to a barrier fixation hardware (e.g., a deadbolt, other barrier fixation hardware, latch, seal, etc.), that prevents the movement of the barrier. The identity receiver can actuate the barrier fixation hardware directly, or actuate a locking mechanism that engages to prevent movement of the barrier fixation hardware and disengage to allow free movement of the barrier fixation hardware. In the latter case, once the locking mechanism is disengaged, a user can manually disengage the barrier fixation hardware. That is, the locking mechanism functions as a secondary fixation hardware that indirectly prevents movement of the barrier. In some embodiments, the locking mechanism can be a tertiary fixation hardware or quaternary fixation hardware that indirectly prevents movement of the barrier fixation hardware.

The identity receiver determines whether to grant access through the security system based on the information it receives from the mobile device. The disclosed security system enables extraction of identity information by having a mobile device responding to a handover message from one communication protocol to another. For example, the mobile device may be an NFC enabled mobile device that uses the NFC protocol to discover a unique identifier of the mobile device, where the unique identifier is associated with a second communication channel and protocol. For example, the unique identifier can be a communication protocol ID (e.g., a media access control (MAC) address), or the combination of such communication protocol ID with other identifiers in the mobile device. “Unique” as discussed in this disclosure refers to absolute uniqueness or substantial uniqueness where the likelihood of two devices with the same identifier is extremely low. Once access is granted, the identity receiver can disengage the locking mechanism or the barrier fixation hardware.

The disclosed security system involves a mechanism to extract an identification of a general-purpose mobile device without requiring specific software, and thus overcoming the problem of uncooperative hardware vendor (e.g., one that does not expose access to unique identifiers in the mobile device to third party applications or devices). For example, the identity receiver can use identity data based on connection/communication protocol information from the mobile device to uniquely identify the mobile device. This would enable the security system, and particularly the identity receiver, to uniquely identify the general-purpose mobile device to either grant or refuse access in situations where the handset vendors prevent mobile applications associated with the identity receiver to be executed or to extract device-specific information.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 is a block diagram of an example system environment of a security system, in accordance with various embodiments.

FIG. 2 is a block diagram of an example identity receiver, in accordance with various embodiments.

FIG. 3 is a diagrammatic representation of a mobile device, in accordance with various embodiments.

FIG. 4 is a flow chart of a method of an identity receiver acquiring a unique identifier from a mobile device, in accordance with various embodiments.

FIG. 5 is a flow chart of a method of the identity receiver authenticating a mobile device, in accordance with various embodiments.

FIG. 6A is a control flow illustrating an example of an NFC handover process, in accordance with various embodiments.

FIG. 6B is an example of an NFC handover message, in accordance with various embodiments

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

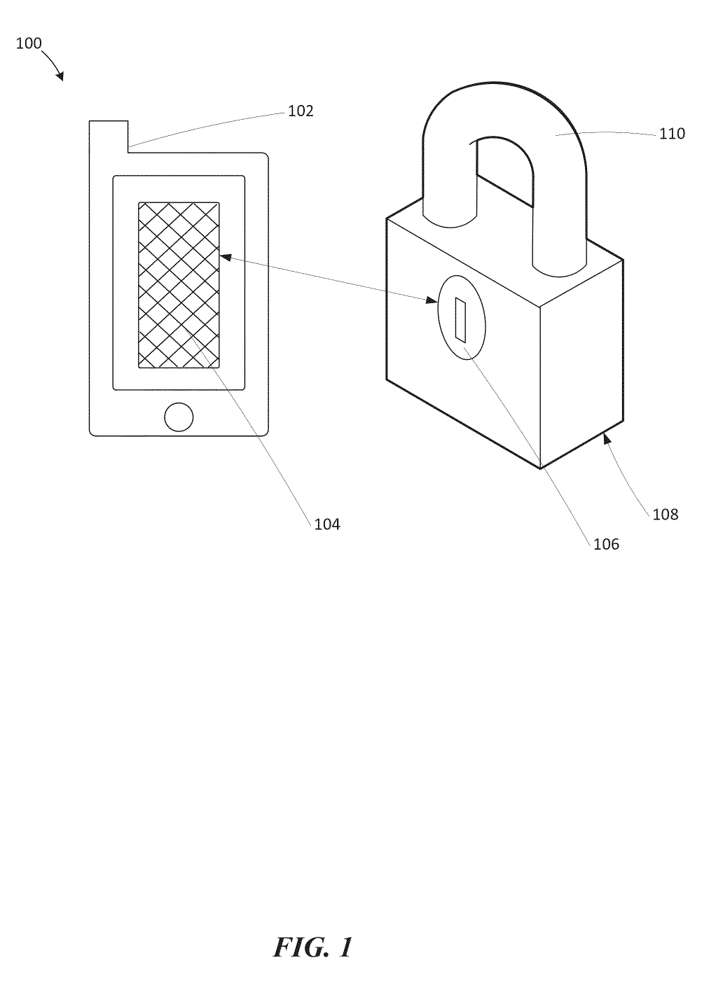

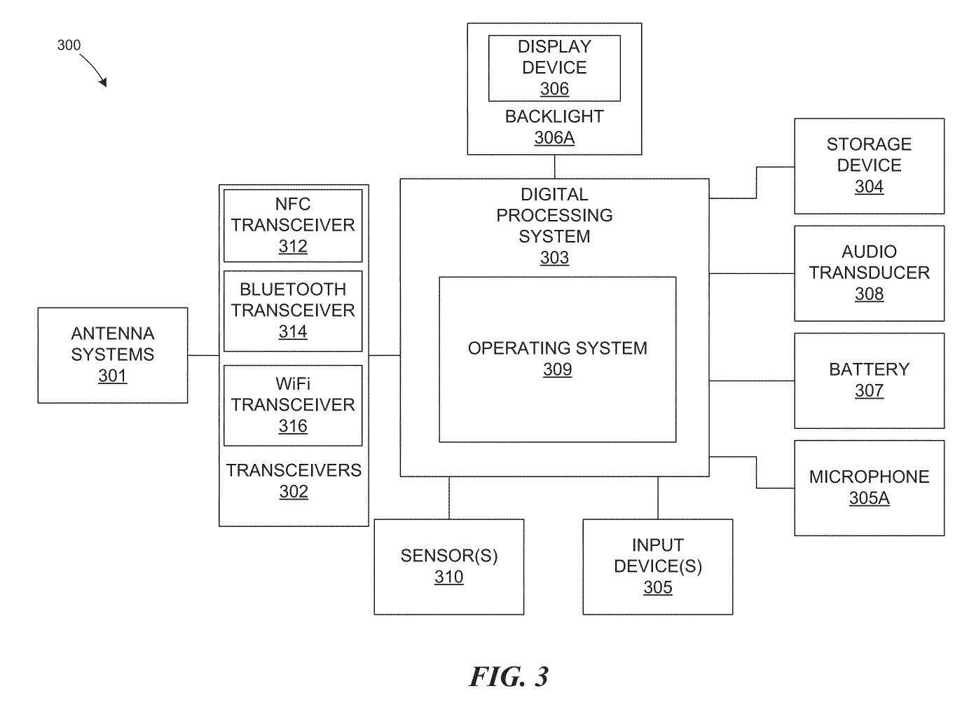

FIG. 1 is a block diagram of an example system environment of a security system 100, in accordance with various embodiments. The security system 100 is configured to authenticate a mobile device 102. Specifically, the mobile device 102 has been illustrated to implement a NFC module 104. However, other communication module operating under other communication protocol may be used in accordance with various embodiments. The NFC module 104, for example, can implement a standard NFC protocol, such as defined in ISO/IEC 18092/ECMA-340 or ISO/IEC 21481/ECMA-352 or other standards defined by the GSM Association, the Store Logistics and Payment with NFC consortium, or the NFC Forum. In some embodiments, the mobile device 102 may be the mobile device 300 of FIG. 3. The mobile device 102 may be capable of near field communication through the NFC module 104.

The NFC module 104 can communicate with an identity receiver 106. For example, the NFC module 104 may communicate in at least two different modes. In a passive communication mode, the NFC module 104 can generate a carrier field and the identity receiver 106 can answer in response by modulating the carrier field. In some embodiments, the identity receiver 106 can generate the carrier field instead, and the NFC module 104 can answer by modulating that field. In this mode, the identity receiver 106 may draw its operating power from electromagnetic field provided by the NFC module 104, thus making the identity receiver 106 a transponder.

In an active communication mode, both the NFC module 104 and the identity receiver 106 communicate by alternately generating their own fields. A device deactivates its RF field while it is waiting for data. In this mode, both devices may have power supplies.

The security system 100 is guarded by the identity receiver 106, which can couple with the NFC module 104 wirelessly to receive identifying information and to attempt to authenticate the identifying information before granting access. The identity receiver 106 may also be capable of NFC. The identity receiver 106 may be coupled directly or indirectly to a security mechanism 108. The security mechanism 108 secure via a physical barrier, a virtual barrier, or a combination thereof. For example, the security mechanism 108 can include or be part of a lock, a door, a latch, or other systems for securing access. The security mechanism 108 including a physical barrier can further include barrier fixation hardware 110. The identity receiver 106 may be a component within the security mechanism 108. For example, the security mechanism 108 can be a lock cylinder, and the identity receiver 106 can be implemented within the lock cylinder. The identity receiver 106 may be detachably coupled to the security mechanism 108. In the example of the security mechanism 108 securing via a physical barrier, the identity receiver 106 can cause disengagement of the barrier fixation hardware 110 directly or indirectly enable the disengagement of the barrier fixation hardware 110 (e.g., by disengaging a locking mechanism that prevents movement of the barrier fixation hardware 110).

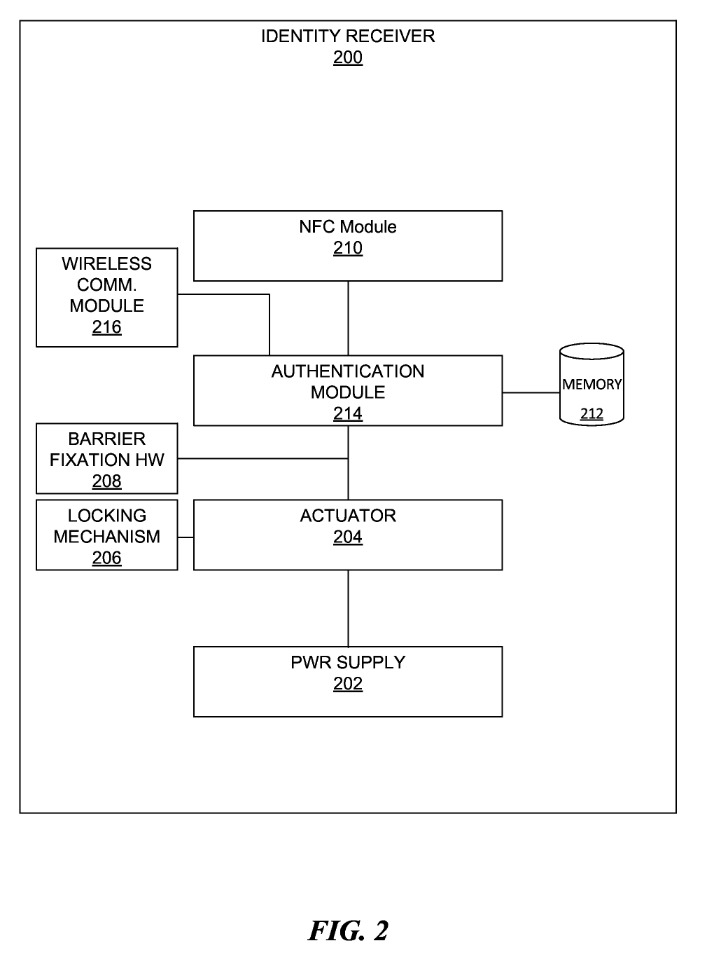

FIG. 2 is a block diagram of an example identity receiver 200, in accordance with various embodiments. The identity receiver 200 may be the identity receiver 106 of FIG. 1. The identity receiver 200 may optionally include a power supply 202 and an actuator 204. The power supply 202 can supply the power necessary to operate electronic circuitry (e.g., an authentication module 214 and/or an NFC module 210) for running the identity authentication process. The power supply 202 can also supply power to drive the actuator 204. For example, the actuator 204 operates a locking mechanism 206 or a barrier fixation hardware 208. The barrier fixation hardware 208, when engaged, prevents access through a barrier; and when disengaged, allows access through the barrier. The locking mechanism 206, when engaged, prevents movement of the barrier fixation hardware 208; and when disengaged, allows movement of the barrier fixation hardware 208.

The power supply 202 may be an internal energy source, such as a battery. Alternatively, the power supply 202 may be a converter for connecting to an external energy source via a wire or wirelessly. For example, the power supply 202 may derive its power from the energy field generated by a nearby device, such as energy field generated by the NFC module 104 of the mobile device 102 of FIG. 1 (e.g., without contacting the mobile device).

The identity receiver 200 may include the NFC module 210. The NFC module 210 is configured to receive NFC signal from an external NFC module, such as the NFC module 104 of FIG. 1. The NFC module 210 may be operating under either the active or passive mode as described above. In some embodiments, the NFC module 210 operate as the master, and generates the carrier field for the near field communication with the external NFC module. In some embodiments, the NFC module 210 operates as the slave, and modulates a carrier field generated by the external NFC module. It is noted that the NFC module 210 may transmit information as well as receive information, either under the passive mode or the active mode. In some embodiments, the NFC module 210 may be coupled to the power supply 202, for example, to power NFC communication in the active mode.

The identity receiver 200 may include a memory 212. The memory 212 may be preferably a non-volatile tangible storage. In some examples, the memory 212 can be a volatile tangible storage. The memory 212 can store one or more identities. The identities may be represented as digital strings, such as MAC addresses of mobile devices' Bluetooth radio or Wi-Fi adapter. Potential digital strings that can serve to identify mobile devices may include: the MAC address of Bluetooth radio, MAC address of Wi-Fi radio, UDID (Apple iPhone's unique device identifier), Android ID (Android operating system's unique ID), international mobile equipment identity (IMEI), international mobile subscriber identity (IMSI), or any combination thereof. The identity of the mobile device can also include a hash of one or more of the above digital strings.

The identity receiver 200 may include an authentication module 214. The authentication module 214 is coupled to the NFC module 210. When the NFC module 210 receives an energy field from a nearby mobile device, the authentication module 214 may create an NFC data exchange format (NDEF) record. An NFC enabled mobile device is configured to read the NDEF record when its energy field (e.g., magnetic induction field of the NFC) has been changed by a nearby receiver. The NDEF record may include information regarding how to connect with the identity receiver 200 via a second channel, such as Wi-Fi or Bluetooth. When a mobile device attempts to connect with the identity receiver 200 via Wi-Fi or Bluetooth, the mobile device will send its Bluetooth or Wi-Fi MAC address. The authentication module 214 then captures such MAC address via the NFC module 210 and stores it as an identity (e.g., a digital string).

The use of the NDEF record described above may be in accordance with a handover protocol of the NFC protocol stack (e.g., according to a NFC standard). The handover protocol may require transmission of network access data and credentials (the carrier configuration data) to allow one device to connect to a wireless network provided by another device (e.g., Bluetooth or WiFi). Because of the close proximity needed for communication between NFC devices and tags, eavesdropping of carrier configuration data is difficult without recognition by the legitimate owner of the devices. Thus carrier configuration data can be transmitted between devices when brought to close proximity of each other. The authentication module 214 can store the received identity when configured in the key acquisition mode.

Later on when the authentication module 214 detects the same identity digital string, the authentication module 214 can instruct the actuator 204 to open access to whatever the identity receiver 200 is securing (e.g., the locking mechanism 206 or the barrier fixation hardware 208). In the case of a virtual security system, the authentication module 214 can provide digital access (e.g., providing a secured channel for the authenticated mobile device to access information). The authentication module 214 may also provide a uniform resource locator (URL) through a NDEF record. The mobile device can open the URL once the NDEF record is received. A Web server (not shown) can then display the status of the authentication request, including an access denial, an access grant, a try again, or any other message. In some embodiments, the identity receiver 200 can update in real time, periodically, or according to a conditional schedule, the status of authentication requests to the Web server, such as by communicating through a wireless communication module 216. The identity receiver 200 can also synchronize a control list of allowed or blacklisted identities with the Web server, the mobile device, or both (either synchronize from the identity receiver 200 or to the identity receiver 200).

The modules described within may be implemented as hardware modules, software modules, or any combination thereof. For example, the modules described can be software modules implemented as instructions on a tangible storage memory capable of being executed by a controller on a machine. The tangible storage memory may be non-transitory. Software modules may be operable when executed by the controller, such as a single board chip, a processor, a field programmable gate array, an application-specific integrated circuit (ASIC), a network capable computing device, a virtual machine, a cloud-based computing terminal device, or any combination thereof.

Each of the modules may operate individually and independently of other modules. Some or all of the modules may be executed on the same host device or on separate devices. The separate devices can be coupled via a communication module to coordinate its operations. Some or all of the modules may be combined as one module.

A single module may also be divided into sub-modules, each sub-module performing separate method step or method steps of the single module. In some embodiments, the modules can share access to a memory space. One module may access data accessed by or transformed by another module. The modules may be considered “coupled” to one another. The modules can directly or indirectly share a physical connection, a virtual connection, or both, allowing data accessed or modified from one module to be accessed in another module. In some embodiments, some or all of the modules can be upgraded or modified remotely. The memory 212 can be coupled to one or more of the modules. The identity receiver 200 may include additional, fewer, or different modules for various applications.

FIG. 3 is a diagrammatic representation of a mobile device 300, in accordance with various embodiments. The mobile device 300 may be the mobile device 102 of FIG. 1, although alternative embodiments of those devices may include more or fewer components than the mobile device 300.

Mobile device 300 may include one or more antenna systems 301. Mobile device 300 may also include one or more digital and/or analog radio frequency (RF) transceivers 302, coupled to the antenna systems 301, to transmit and/or receive voice, digital data and/or media signals through antenna systems 301.

Mobile device 300 may also include a digital processing system 303 to control the digital RF transceiver and to manage the voice, digital data and/or media signals. Digital processing system 303 may be a general-purpose processing device, such as a microprocessor or controller for example. Digital processing system 303 may also be a special purpose processing device, such as an ASIC (application specific integrated circuit), FPGA (field-programmable gate array) or DSP (digital signal processor). Digital processing system 303 may also include other devices, as are known in the art, to interface with other components of mobile device 300. For example, digital processing system 303 may include analog-to-digital and digital-to-analog converters to interface with other components of mobile device 300. Digital processing system 303 may include an operating system 309 implemented by a general-purpose or special purpose processing device, such as a processor and non-transitory tangible storage medium. For example, the storage medium can store instructions that may be executed by the processor to implement the operating system 309.

Mobile device 300 may also include a storage device 304, coupled to the digital processing system, to store data and/or operating programs for the mobile device 300. Storage device 304 may be, for example, any type of solid-state or magnetic memory device.

Mobile device 300 may also include one or more input devices 305, coupled to the digital processing system 303, to accept user inputs (e.g., telephone numbers, names, addresses, media selections, etc.) Input devices 305 may include, for example, one or more of a keypad, a touchpad, a touch screen, a pointing device in combination with a display device or similar input device.

Mobile device 300 may also include at least one display device 306, coupled to the digital processing system 303, to display information such as messages, telephone call information, contact information, pictures, movies and/or titles or other indicators of media being selected via the input devices 305. Display device 306 may be, for example, an LCD display device. In one embodiment, one or more of the display device 306 and the input devices 305 may be integrated together in the same device (e.g., a touch screen LCD such as a multi-touch input panel which is integrated with a display device, such as an LCD display device). The display device 306 may include a backlight 306A to illuminate the display device 306 under certain circumstances. It will be appreciated that the Mobile device 300 may include multiple displays.

Mobile device 300 may also include a battery 307 to supply operating power to components of the system including the transceivers 302, digital processing system 303, storage device 304, input devices 305, microphone 305A, audio transducer 308, operating system 309, sensor(s) 310, and display device 306. Battery 307 may be, for example, a rechargeable or non-rechargeable lithium or nickel metal hydride battery. Mobile device 300 may also include the audio transducer 308, which may include one or more speakers, and at least one microphone 305A. In certain embodiments of the present disclosure, the mobile device 300 can be used to implement at least some of the methods discussed in the present disclosure.

The operating system 309 can implement various communication protocols specific to various types of the transceivers 302, including a NFC transceiver 312, a Bluetooth transceiver 314, a Wi-Fi transceiver 316, or any combination thereof. The operating system 309, for example, can be configured to generate an energy field via the NFC transceiver 312. The operating system 309 can configure the NFC transceiver 312 to monitor for modulations in an observed energy field monitored by the NFC transceiver 312 (e.g., a passive or an active modulation). The operating system 309 can detect a NDEF record based on the modulation determined from the observed energy field. The NDEF record can include information regarding how to connect with an identity receiver (e.g. the identity receiver 200) via a second channel, such as via the Bluetooth transceiver 314 or the Wi-Fi transceiver 316. In response, the operating system 309 can provide the MAC address of the requested second channel via near field communication through the NFC transceiver 312. The NDEF record can also include a URL. In response, the operating system can launch a default browser of the operating system 309 to retrieve a webpage from the URL.

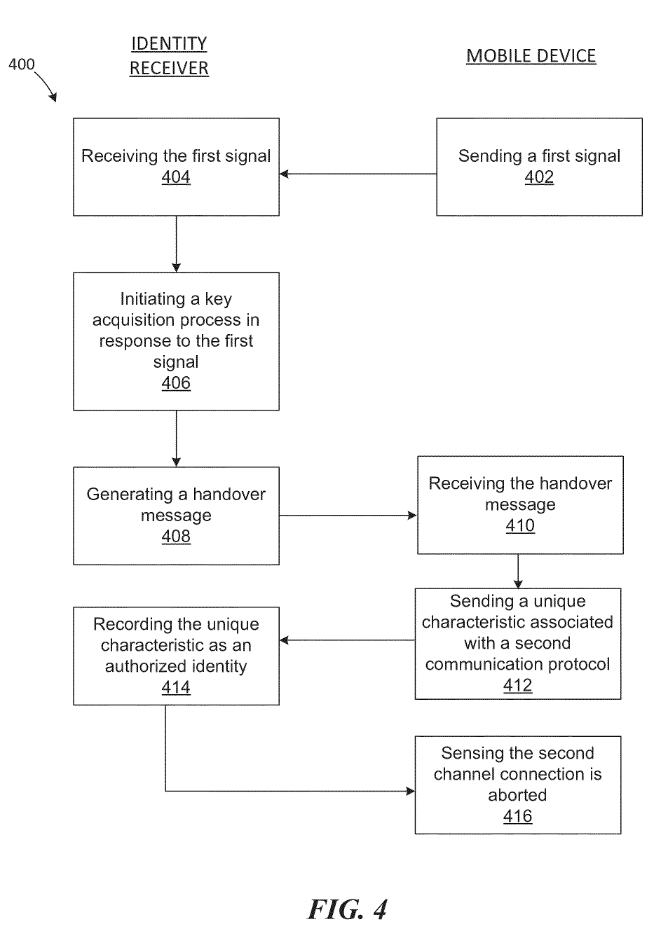

FIG. 4 is a flow chart of a method 400 of an identity receiver acquiring a unique identifier from a mobile device. The identity receiver, for example, may be the identity receiver 106 of FIG. 1 or the identity receiver 200 of FIG. 2 that is part of a security system (e.g., the security system 100 of FIG. 1). The mobile device, for example, may be the mobile device 102 of FIG. 1 or the mobile device 300 of FIG. 3. This method may be performed under a key acquisition mode, where the identity receiver is waiting to receive an unique characteristic of the mobile device to save as an authorized identity. That is, prior to initiating the method 400, the identity receiver may first be configured in the key acquisition mode (e.g., by pressing a button or changing a switch on the interior side of the identity receiver or by remote configuration). The interior side refers to the direction towards where access is prevented by a physical barrier security system).

The method 400 may include step 402 of the mobile device sending a first signal via a first communication protocol, such as the NFC protocol. The first communication protocol can also be other contactless or contact-based communication protocol. The method 400 may then include step 404 of the identity receiver receiving the first signal. For example, step 404 can include the identity receiver detecting an attempt of near field communication. Step 404 may optionally include powering the identity receiver with the received first signal. Step 404 may also include the identity receiver capturing the power received from the NFC signal to further modulate the energy field of the NFC signal. The identity receiver then initiates a key acquisition process in response to the first signal (e.g., by initiating an NFC peer to peer mode) in step 406. The key acquisition process begins with requesting, via a handover message, the mobile device to communicate with the identity receiver over a second channel using a second communication protocol, such as Wi-Fi or Bluetooth. The handover message is configured to request the mobile device to switch from communicating via the first communication protocol to the second communication protocol. To accomplish this, the identity receiver can generate the handover message (e.g., a NDEF record) containing information referencing the second communication protocol in step 408. In some embodiments, the second communication protocol are related communication protocols. In other embodiments, the second communication protocol and the first communication protocol are completely unrelated. For example, the handover message may contain a random Bluetooth adapter address. Other examples of the communication protocols include iBeacon, ZigBee, Z-Wave, WirelessHART/Dust Networks, ISA 100a, different WiFi standards (e.g., 802.15.4or 802.11), ISM-band-based channels, IMEI, ANT or ANT+, or other methods of communication.

The mobile device can scan for a response after sending the first signal, such as NFC modulation of the first signal. The mobile device then receives the handover message in step 410. For example, the mobile device can retrieve the information regarding the second channel, such as Bluetooth or Bluetooth LE or Wi-Fi (e.g., regular Wi-Fi or Wi-Fi Direct), from the NDEF record. The mobile device can send a unique characteristic (e.g., a unique identifier) associated with the second communication protocol (e.g., its Bluetooth and/or Wi-Fi MAC address(s)) to the identity receiver in step 412. In some embodiments, the mobile device operating system can automatically send the MAC address when a Wi-Fi or Bluetooth connection is requested.

Alternatively the mobile device can send any other characteristic of the mobile device of which can uniquely identify the mobile device. The identifying characteristic can be a digital number that is embedded or stored within components of the mobile device. The unique characteristic can be sent via the first channel or the second channel.

Once the unique characteristic is received, the identity receiver can record/store the unique characteristic (e.g., the unique identifier) as an authenticated identity in step 414. In this scenario, when the mobile device detects that the second channel connection is aborted by the identity receiver in step 416, no further instructions are performed in response.

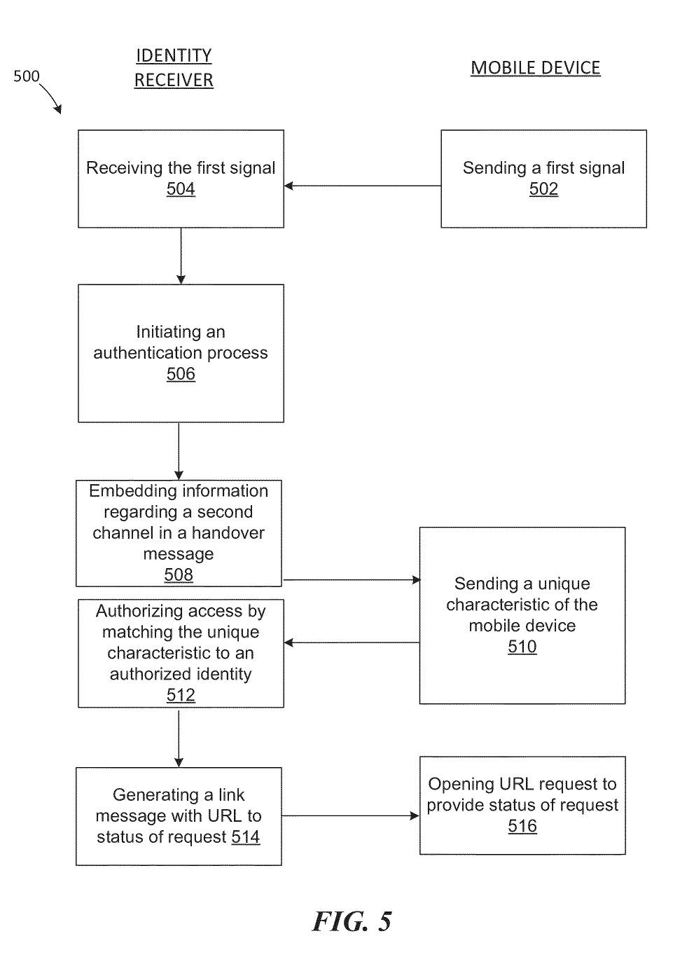

FIG. 5 is a flow chart of a method 500 of an identity receiver authenticating a mobile device, in accordance with various embodiments. The identity receiver, for example, may be the identity receiver 106 of FIG. 1 or the identity receiver 200 of FIG. 2 that is part of a security system (e.g., the security system 100 of FIG. 1). The mobile device, for example, may be the mobile device 102 of FIG. 1 or the mobile device 300 of FIG. 3. The method 500 may include steps similar to the method 400. The mobile device sends a first signal (e.g., NFC signal) via a first communication protocol in step 502. The identity receiver receives the first signal in step 504 and initiates an authentication process (e.g., by initiating the NFC peer-to-peer mode) in step 506. The identity receiver then embeds information regarding a second channel in a handover message (e.g., a NDEF record) to the mobile device via the first communication protocol in step 508. The handover message is configured to initiate a handover process to switch from communicating via a first communication protocol to a second communication protocol of the second channel.

The method 500 is implemented for the identity receiver to authenticate the mobile device. However, in some embodiments, the security system may implement a bi-directional authentication process. Hence, in some embodiments, before steps 502, 504, or 506, the mobile device can first attempt to authenticate the identity receiver.

The mobile device can send its unique characteristic (e.g., a unique identifier associated with the second channel) in response to reading the handover message in step 510. The mobile device can send one or more unique characteristics. When the identity receiver receives the unique characteristics, the identity receiver can abandon the handover process. That is, the handover message is configured to cause the mobile device to send its one or more of the unique characteristics, and not to actually switch to another communication protocol. This feature takes advantage of the handover message to solve the problem of a restrictive operating system on the mobile device that prevents a third-party security application running on the operating system to access to the unique characteristics.

When the unique characteristics, such as a MAC address or a mobile device identifier, match identifiers of an authorized digital identity stored on the identity receiver, the identity receiver grants access through a barrier (e.g., a physical or virtual barrier) in step 512. For example, granting access can include disengaging a barrier fixation hardware or a locking mechanism that prevents movement of the barrier fixation hardware. When the unique characteristics do not match an authorized digital identity, then the identity receiver denies access. The identity receiver can store a record of the attempt to gain access and whether access was granted or denied. This record can be shared on a Web server coupled to the identity receiver.

At a point during the authentication process of the method 500, the identity receiver may generate a link message (e.g., a NDEF record) with a URL pointing to the Web server coupled to the identity receiver in step 514. For example, the identity receiver may be in wireless communication with the web server. Alternatively, the identity receiver can host its own web service server, such as via wireless communication.

The web server can generate a webpage at the URL indicating the status of the authentication process, such as granting, denying, requesting further information, or requesting downloading of a mobile application. Upon receiving the link message with the URL, the mobile device can open the URL and see the status of its authentication process at the URL in step 516.

Similar to the method 400, once the unique characteristic is received, the identity receiver can use the unique characteristics to authenticate the mobile device, such as in step 512. Afterwards, the identity receiver can abort the second channel connection. In some embodiments, when the mobile device detects that the second channel connection is aborted by the identity receiver, no further instructions are performed in response.

The key acquisition process of the method 400 and the authentication process of the method 500 can be implemented to facilitate the operations of a security. However, it is contemplated by this disclosure that the same key acquisition process and authentication process can apply to other use cases as well, such as targeted advertising or license control.

While processes or blocks are presented in a given order in FIGS. 4-5, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times.

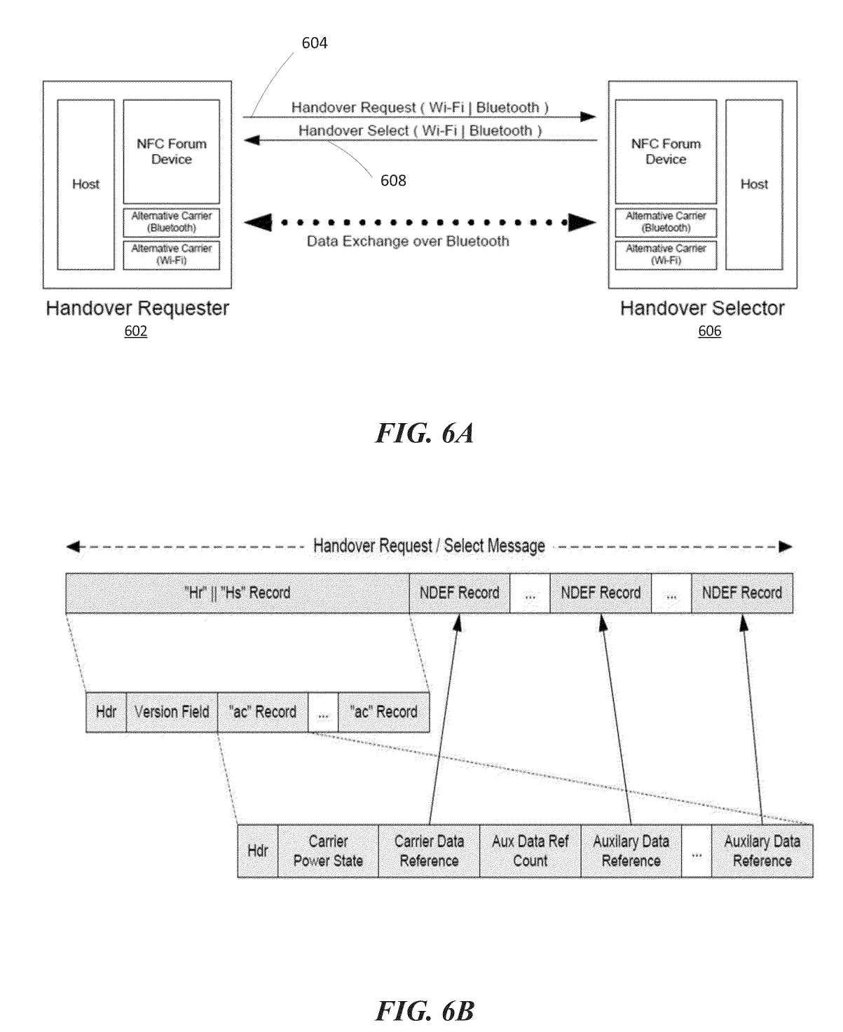

FIG. 6A is a control flow illustrating an example of an NFC handover process, in accordance with various embodiments. There are multiple handover mechanisms specified by the NFC protocol stack. FIG. 6A illustrates at least one of the mechanisms in the form of a negotiated handover. In this case, a handover requester 602 (e.g., an initiator device) sends a request message 604 to a handover selector 606 (e.g., a receiving device). The handover selector 606 sends a response message 608 to the handover requester 602. The handover requester 602 can be the identity receiver 106 of FIG. 1 or the identity receiver 200 of FIG. 2. The handover selector 606 can be the mobile device 102 of FIG. 1 or the mobile device 300 of FIG. 3.

The handover selector 606 may support multiple carrier channels (e.g., Bluetooth and Wi-Fi) other than NFC. The response message 608 may include a list of the carrier channels. Conventionally, when the response message 608 arrives to the handover requester 602, then the handover requester 602 can pick the best possible carrier that matches for both devices. In embodiments, the handover requester 602 extracts embedded identifiers associated with the carrier channels for access authorization purposes.

FIG. 6B is an example of an NFC handover message (e.g., the request message 604 or the response message 608), in accordance with various embodiments. When an application need to use an alternative carrier by using the NFC handover process, the handover requester 602 can construct the request message 604 that is transferred to the handover selector 606. This request message 604 is constructed by using the NDEF. The handover selector 606 constructs the response message 608 where it describes the properties of its alternative carrier(s). This alternative carrier information is used by the handover requester 602 to connect to the handover selector 606.

The handover message is composed of either a Handover Request Record (NFC Forum Global Type “Hr”) or a Handover Select Record (NFC Forum Global Type “Hs”), followed by an arbitrary number of other NDEF records. Within a Handover Request or Handover Select Record, a sequence of Alternative Carrier Records (NFC Forum Local Type “ac”) defines the alternative carriers that are requested or selected, respectively.

What is claimed is:

1. An identity receiver of a security system, comprising:
a near field communication (NFC) receiver configured to receive an NFC signal from a mobile device;
a memory configured to store an authorized identity; and
an authorization engine, coupled to the memory and the NFC receiver, configured to:
generate an NFC data exchange format (NDEF) record to request a wireless connection with the mobile device other than NFC;
receive a network interface identifier of the mobile device corresponding to the requesting of the wireless connection, in response to the NDEF record; and
authorize access through the security system when the network interface identifier matches the authorize identity.

2. The identity receiver of claim 1, further comprising:
a locking mechanism; and
an actuator configured to disengage the locking mechanism when access through the security system is authorized.

3. The identity receiver of claim 1, wherein the authorization engine is configured to abort connecting via the wireless connection once the network interface identifier is received.

4. A method of operating a security system to process an authentication request comprising:
detecting an energy signal using a first communication protocol from a mobile device at an identity receiver;
generating a handover message at the identity receiver to request a unique characteristic of the mobile device, the unique characteristic associated with a second communication protocol;
receiving the unique characteristic from the mobile device at the identity receiver; and
authorizing access through the security system by matching the unique characteristic to an authorized identity stored in the identity receiver.

5. The method of claim 4, further comprising, abandoning a handover process initiated by the handover message in response to receiving the unique characteristic.

6. The method of claim 4, further comprising, in response to authorizing access, sending a command to disengage a locking mechanism that prevents movement of a barrier fixation device, which prevents access through a barrier of the security system, or to disengage the barrier fixation device directly.

7. The method of claim 4, wherein the first communication protocol is a NFC-based communication protocol.

8. The method of claim 7, further comprising, in response to detecting the energy signal, initiating a NFC peer to peer mode at the identity receiver.

9. The method of claim 7, wherein generating the handover message includes generating a first NDEF record to request a unique address associated with a component of the mobile device used to communicate using the second communication protocol.

10. The method of claim 9, wherein generating the first NDEF record includes formatting the first NDEF record to cause a NFC handover process, wherein the first NDEF record indicates an intent to switch to a second channel to communicate via the second communication protocol.

11. The method of claim 4, wherein the unique characteristic is a media control access (MAC) address of a radio.

12. The method of claim 11, wherein the unique characteristic is the MAC address of a Bluetooth network interface.

13. The method of claim 11, wherein the unique characteristic is the MAC address of a WiFi network interface.

14. The method of claim 4, wherein the mobile device is a general-purpose mobile device with an operating system, wherein the operating system restricts access to the unique characteristic via a third party application running on the operating system.

15. The method of claim 4, wherein the identity receiver is or is part of a NFC-enabled lock cylinder.

16. The method of claim 4, further comprising generating a link message using the first communication protocol at the identity receiver for the mobile device, the link message containing a URL to indicate a status of the authentication request.

17. The method of claim 4, further comprising generating a link message using the first communication protocol at the identity receiver for the mobile device, the link message configured to prompt the mobile device to install an application associated with the identity receiver.

18. A method of operating a security system comprising:
detecting an energy field of Near Field Communication (NFC) from a mobile device at an identity receiver;
generating an NFC data exchange format (NDEF) record at the identity receiver to request a unique characteristic of the mobile device;
receiving the unique characteristic from the mobile device at the identity receiver; and
storing the unique characteristic as an authorized identity on the identity receiver.

19. The method of claim 18, further comprising configuring the identity receiver in a key acquisition mode.

20. The method of claim 18, wherein the unique characteristic is based on one or more embedded identifiers of the mobile device.

21. The method of claim 20, wherein the unique characteristic is a hash of one or more embedded identifiers of the mobile device.

22. The method of claim 18, wherein generating the NDEF record includes formatting the NDEF record according to a NFC protocol stack to obtain the unique characteristic from the mobile device.
